(19) United States
(12) Patent Application Publication
(10) Pub. No.: US 2016/0349747 A1
(43) Pub. Date: Dec. 1, 2016

(54) REMOTE CONTROL SYSTEM FOR WORKING MACHINE THROUGH A MOTION SENSITIVE GLOVE

(71) Applicant: ZIRVE UNIVERSITESI, Gaziantep (TR)

(72) Inventor: Hüseyin Emre KANKAYA, Gaziantep (TR)

(21) Appl. No.: 14/940,933

(22) Filed: Nov. 13, 2015

(30) Foreign Application Priority Data
May 29, 2015 (TR) 2014/16403

(51) Int. Cl. G05D 1/00; A41D 19/00; G05B 15/02

(52) U.S. Cl. CPC G05D 1/0016; G05B 15/02; A41D 19/00

(57) ABSTRACT

A remote control system for working machines includes a motion sensitive glove, worn by an operator, with motion sensors that sense the movement of the operator by being positioned on the joint regions of the operator such as fingers, hand, elbow, and shoulders, a motion sensitive glove control and communication unit that includes a microcontroller forming necessary instructions for the processes that will be performed by the working machine by processing the incoming data from the motion sensitive glove and that transmits these information to the working machine wirelessly, and a working machine control and communication unit that receives the incoming instructions from the motion sensitive glove control and communication unit and that performs these instructions via its microcontroller.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a system that provides remote control for a working machine, such as a bulldozer or other piece of heavy machinery, by a motion sensitive glove worn by an operator.

2. Description of Related Art Including Information Disclosed Under 37 CFR 1.97 and 37 CFR 1.98.

Today, working machines are controlled manually from the vehicle cabin. In this application, operators must be present in the vehicle cabin. Thus, operators work under threat due to possible accidents.

Working machines can also be controlled by remote control systems. U.S. Pat. No. 8,428,791B2 describes a system developed to provide remote control for a working machine. In these systems, the possibility for the operators being harmed due to accidents is reduced by eliminating the necessity for the operators being present in the vehicle cabin. In these systems, however, the controlling process is performed via complex arms, pedals, and buttons. Therefore, their use is not practical and is difficult for operators.

These problems have necessitated a novelty in the related art.

### BRIEF SUMMARY OF THE INVENTION

The present invention relates to a remote control system for a working machine, which is developed to remove the abovementioned disadvantages and to bring new advantages to the related technical field.

The main purpose of the invention is to provide remote control for a working machine, to eliminate the necessity for the operators being present in the vehicle cabin and thus introduce a control system for working machines that ensures the operators work in a safe environment.

Another purpose of the invention is to introduce a control system for a working machine which is easy to learn and use and controlled by the body movements of the operator.

In order to achieve all purposes mentioned above and emerged from the detailed description below, the present invention relates to a system that provides remote control for the working machine. The said system includes:
a motion sensitive glove, worn by an operator, with motion sensors that sense the movement of the operator by being positioned on the joint regions of the operator such as fingers, hand, elbow, and shoulders, etc.,
a motion sensitive glove control and communication unit that includes a microcontroller forming necessary instructions for the processes that will be performed by the working machine by processing the incoming data from the said motion sensitive glove and that transmits these information to the working machine wirelessly,
a working machine control and communication unit that receives the incoming instructions from the said motion sensitive glove control and communication unit and that performs these instructions via its microcontroller.

In a preferred embodiment of the invention, the motion sensitive glove control and communication unit includes a signal conditioning circuit which converts the incoming data from moving gloves into a form that can be interpreted by microcontroller.

In another preferred embodiment of the invention, motion sensitive glove control and communication unit includes a wireless transmitter module which transmits the instructions formed by the microcontroller to the working machine control and communication unit.

In another preferred embodiment of the invention, the working machine control and communication unit includes a wireless receiver module which receives the incoming data from the motion sensitive glove control and communication unit.

In another preferred embodiment of the invention, the working machine control and communication unit includes a control interface circuit to which instructions coming from the microcontroller are transmitted and which allows functional parts and motors of the working machine to perform these instructions.

Other preferred embodiment of the invention includes connecting cables that provides the communication between the motion sensitive glove and the motion sensitive glove control and communication unit.

Embodiments of the present invention and its advantages with additional components should be evaluated together with the drawings described below to better understand them.

### BRIEF DESCRIPTION OF THE SEVERAL VIEWS OF THE DRAWINGS

FIG. 1 is a representative view of the remote control system for a working machine.

FIG. 2 is a schematic view of the remote control system for a working machine.

### REFERENCE NUMBERS

1 Working machine
1.1 Functional parts
1.2 Motors
2 Working machine control and communication unit
2.1 Wireless receiver module
2.2 Microcontroller
2.3 Control interface circuit
3 Motion sensitive glove control and communication unit
3.1 Signal conditioning circuit
3.2 Microcontroller
3.3 Wireless transmitter module
4 Motion sensitive glove
4.1 Motion sensors
5 Connecting cables

### DETAILED DESCRIPTION OF THE INVENTION

In this detailed description, only for better understanding the subject, the innovation of the present invention is described by way of examples without any limiting effect. The system according to invention relates to a remote control system including the use of a motion sensitive glove (4) worn by an operator to provide a remote control for functional parts (1.1) and motors (1.2) of working machines (1).

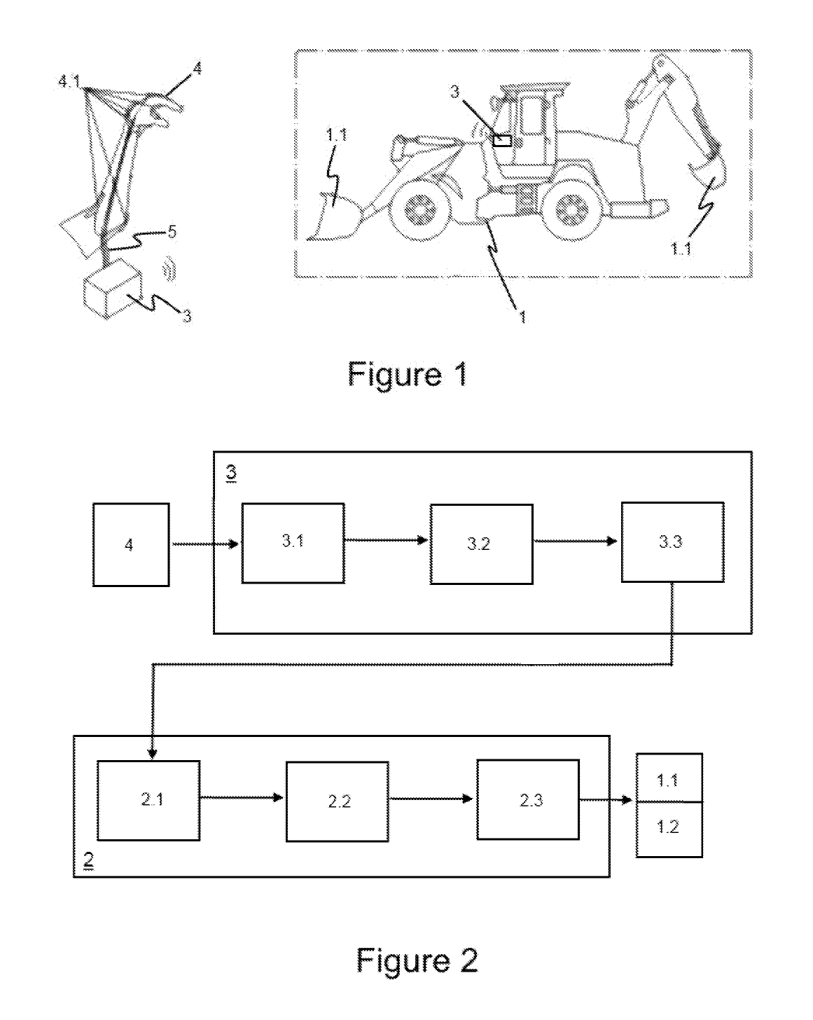

FIG. 1 is a schematic view of the remote control system for a working machine. Accordingly, the system mainly includes a working machine control and communication unit (2) placed in the working machine (1), a motion sensitive glove control and communication unit (3) that can communicate with the said working machine control and communication unit (2) wirelessly, and a motion sensitive glove (4) which is worn by an operator to control the working machine (1) and transmits the data to the said motion sensitive glove control and communication unit (3) by sensing the movement of the operator via the motion sensors (4.1) on it. Motion sensitive glove (4) is an electronic garment produced to cover the hand, arm, and depending on the design, shoulder of an individual. The said motion sensors (4.1) sense the movement of the operator by being positioned on the joint regions of the operator such as fingers, hand, elbow, and shoulders, etc. on the motion sensitive glove (4). The communication between motion sensitive glove (4) and motion sensitive glove control and communication unit (3) is provided by connecting cables (5).

FIG. 2 shows the communication between motion sensitive glove control and communication unit (3) and working machine control and communication unit (2) and the subunits thereof. Accordingly, motion sensitive glove control and communication unit (3) includes a signal conditioning circuit (3.1), a microcontroller (3.2), and a wireless transmitter module (3.3). The signal conditioning circuit (3.1) converts the signals coming from motion sensors (3) to a form that microcontroller (3.2) can sense. The microcontroller (3.2) then interprets the converted signals and converts them to the instructions that are required for the working machine (1) to perform. The instructions sent by the microcontroller (3.2) are sent to the working machine control and communication unit (2) by the wireless transmitter module (3.3). The working machine control and communication unit (2) includes a wireless receiver module (2.1), a microcontroller (2.2), and a control interface circuit (2.3). The wireless receiver module (2.1) receives the instructions coming from the wireless transmitter module (3.3) and transmits them to the microcontroller (2.2) as electrical signals. The microcontroller (2.2) sends the incoming signals to the control interface circuit (2.3) to operate the functional parts (1.1) and motors (1.2) of the working machine (1) in a desired way. The control interface circuit (2.3) provides the fulfillment of these instructions.

In line with the abovementioned information, the remote control system for working machine according to the invention works as performs. Firstly, the operator wears the motion sensitive glove (4) with motion sensors placed on the regions such as finger, arm, elbow, shoulder, and etc. Motion sensors (4.1) sense the movements performed by the operator and transmit them to the motion sensitive glove control and communication unit (3) through connecting cables (5). In the current technique, there has been different motion sensing systems. For example, piezoresistive sensor can be used as a motion sensor (4.1). The piezoresistive sensor is made from resistance changing material when it is bent. The amount of movement of a joint can be detected by measuring the changes in the resistance values of sensors. The signal conditioning circuit (3.1) found in the motion sensitive glove control and communication unit (3) transmits the data to the microcontroller (3.2) by converting them into a form that the microcontroller (3.2) can sense. Microcontroller (3.2) interprets the converted signals and senses the movement digitally. According to the sensed movements, microcontroller (3.2) determines the movement that the working machine (1) is required to do. The determined instructions are transmitted to the wireless receiver module (2.1) in the working machine control and communication unit (2) via the wireless transmitter module (3.3). The wireless receiver module (2.1) then transmits the data to the microcontroller (2.2) of the working machine (1). Microcontroller (2.2) transmits the incoming instructions to the control interface circuit (2.3) for the working machine (1) to perform these instructions. The control interface circuit (2.3) provides the fulfillment of the instructions required by the operator by moving the functional parts (1.1), like arm and dipper, and motors (1.2) of the working machine (1).

1. A remote control system for working machines characterized in that it comprises:
a motion sensitive glove, worn by an operator, with motion sensors that sense the movement of the operator by being positioned on the joint regions of the operator such as fingers, hand, elbow and shoulders;
a motion sensitive glove control and communication unit that includes a microcontroller forming necessary instructions for the processes that will be performed by the working machine by processing the incoming data from the said motion sensitive glove and that transmits these information to the working machine wirelessly; and
a working machine control and communication unit that receives the incoming instructions from the said motion sensitive glove control and communication unit and that performs these instructions via its microcontroller.

2. The remote control system according to claim 1, characterized in that the motion sensitive glove control and communication unit comprises a signal conditioning circuit which converts the incoming data from motion sensitive glove into a form that can be interpreted by the microcontroller of the motion sensitive glove control and communication unit.

3. The remote control system according to claim 1, characterized in that motion sensitive glove control and communication unit comprises a wireless transmitter module which transmits the instructions formed by the microcontroller of the motion sensitive glove control and communication unit to a working machine control and communication unit.

4. The remote control system according to claim 1, characterized in that working machine control and communication unit comprises a wireless receiver module which receives the incoming data from motion sensitive glove control and communication unit.

5. The remote control system according to claim 1, characterized in that working machine control and communication unit comprises a control interface circuit to which instructions coming from the microcontroller of the working machine control and communication unit are transmitted and which allows functional parts and motors of the working machine to perform these instructions.

6. The remote control system according to claim 1, characterized in that it comprises connecting cables that provides the communication between the motion sensitive glove and the motion sensitive glove control and communication unit.
